(19) United States
(12) Patent Application Publication
(10) Pub. No.: US 2014/0093791 A1
(43) Pub. Date: Apr. 3, 2014

(54) AIR ELECTRODE FOR METAL AIR BATTERY

(71) Applicants: Yushi SUZUKI, Susono-shi (JP); Sanae OKAZAKI, Sunto-gun (JP)

(72) Inventors: Yushi SUZUKI, Susono-shi (JP); Sanae OKAZAKI, Sunto-gun (JP)

(73) Assignee: TOYOTA JIDOSHA KABUSHIKI KAISHA, Toyota-shi (JP)

(21) Appl. No.: 14/036,656

(22) Filed: Sep. 25, 2013

(30) Foreign Application Priority Data
Sep. 28, 2012 (JP) 2012-218225

(51) Int. Cl. H01M 4/86; H01M 12/02

(52) U.S. Cl. CPC H01M 4/8657; H01M 12/02
USPC 429/405

(57) ABSTRACT

The invention provides a metal air battery with a discharge capacity higher than a conventional one. This is achieved by an air electrode for a metal air battery provided with a layered body including a first layer containing a carbon material, a second layer containing a carbon material, and an intermediate layer containing a solid electrolyte and being positioned between the first layer and the second layer.

### TECHNICAL FIELD

The present invention relates to an air electrode for a metal air battery that utilizes oxygen as an active material for an air electrode.

### BACKGROUND ART

With the recent spread and progress of appliances such as a cell phone, higher capacity of a battery as a power source has been asked for. Under such situation, a metal air battery has drawn attention as a high capacity battery superior to a lithium-ion battery which is currently used generally, since an oxidation-reduction reaction of oxygen is performed at an air electrode by utilizing the oxygen in the air as an active material for the air electrode, and an oxidation-reduction reaction of a metal constituting a negative electrode is performed at the negative electrode, so that charging and discharging are possible respectively allowing high energy density (Non Patent Literature 1).

For increasing the capacity of a lithium air battery, a lithium air battery provided with an air electrode, in which carbon and a solid electrolyte having conductivity for lithium ions as an electrode catalyst are mixed, has been proposed (Patent Literature 1).

### CITATION LIST

### Patent Literature

[Patent Literature 1] Japanese Laid-open Patent Publication No. 2010-244827

### Non Patent Literature

[Non Patent Literature 1] Incorporated Administrative Agency, National Institute of Advanced Industrial Science and Technology: “High performance lithium air battery with new structure was developed”, online press release dated 24 Feb. 2009, (searched on the Internet on 19 Aug. 2011 at <http://www.aist.go.jp/aist_j/press_release/pr2009/pr2009 0224/pr20090224.html>)

### SUMMARY OF INVENTION

### Technical Problem

As described above, a lithium air battery provided with an air electrode with a mixture of carbon and a solid electrolyte has been heretofore proposed aiming at higher capacity of a lithium air battery. However, a metal air battery with a higher capacity is still desired.

### Solution to Problem

The present invention relates to azo air electrode for a metal air battery provided with a layered body comprising:

a first layer comprising a carbon material,
a second layer comprising a carbon material, and
an intermediate layer comprising a solid electrolyte and positioned between the first layer and the second layer.

### Advantageous Effects of Invention

The present invention can provide an air electrode for obtaining a metal air battery with a discharge capacity higher than a conventional one.

### BRIEF DESCRIPTION OF DRAWINGS

FIG. 1 is a cross-sectional schematic diagram representing the constitution of an air electrode for a metal air battery according to the present invention.

FIG. 2 is a cross-sectional schematic diagram representing the constitution of an air electrode according to a Comparative Example.

FIG. 3 is a cross-sectional schematic diagram representing the constitution of an air electrode according to a Comparative Example.

FIG. 4 is a cross-sectional schematic diagram of an example of an electrochemical cell containing a metal air battery constituted with an air electrode according to the present invention.

FIG. 5 is a graph exhibiting discharge characteristics of cells produced in Example 1 and Comparative Examples 1 and 2.

### DESCRIPTION OF EMBODIMENTS

An air electrode for a metal air battery according to the present invention is provided with a layered body comprising a first layer comprising a carbon material, a second layer comprising a carbon material, and an intermediate layer comprising a solid electrolyte and being positioned between the first layer and the second layer.

In a metal air battery, an oxidation-reduction reaction takes place during discharging thereof, in which oxygen in the air is reduced in an air electrode and a metal ion of a negative electrode is oxidized.

It has been found that, as in a conventional metal air battery, when an air electrode formed by mixing solid electrolyte compounds with carbon is used, the solid electrolyte compounds as a catalyst with high oxygen reducing activity are present nearly uniformly in an air electrode. Therefore, a discharge product also tends to precipitate uniformly, and the precipitate tends to deposit all over the air electrode to cause a problem that voids on the gas side (oxygen intake hole side) and on the negative electrode side of the air electrode are occluded to inhibit the supplies of oxygen or metal ions.

To cope with the above problem, the inventors have found an air electrode with a constitution that a solid electrolyte compound with metal ion conductivity serving as a catalyst is positioned midway of an air electrode. By using an air electrode in which a solid electrolyte compound is positioned midway thereof, in a metal air battery, a discharge product can be precipitated midway of the air electrode where the solid electrolyte compound is positioned, so as to secure voids on the gas side and the negative electrode side of the air electrode and maintain the supplies of oxygen and metal ions.

Since the supplies of oxygen and metal ions can be maintained, the discharge characteristic of a metal air battery can be improved.

The constitution of the air electrode for the metal air battery according to the present invention will be described below referring to the drawings.

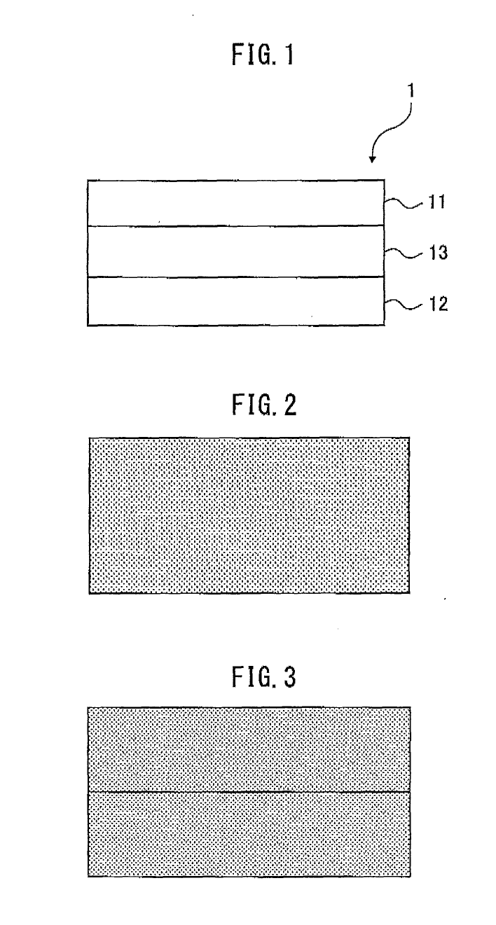

FIG. 1 shows a cross-sectional schematic diagram of the constitution of the air electrode for the metal air battery according to the present invention. As shown in FIG. 1, an air electrode according to the present invention is provided with a layered body including a first layer 11 containing a carbon material, a second layer 12 containing a carbon material, and a solid electrolyte layer 13 positioned between the first layer and the second layer.

A carbon material contained in the first layer and the second layer is preferably a porous material. Preferable examples of the porous material include carbon, and examples of the carbon include carbon black, such as Ketjen black, acetylene black, channel black, furnace black, and mesoporous carbon; active carbon; and a carbon fiber. A carbon material with a larger specific surface area is used more preferably. As the porous material, a material having a pore volume of 1 cc/g or more and a pore size of a nanometer order is preferable. A carbon material occupies preferably 10 to 99 wt % of the first layer and the second layer. The carbon material contained in the first layer and the carbon material contained in the second layer may be the same or different. Preferably, the first layer and the second layer contain the same carbon material.

The first layer and the second layer may contain respectively a binder. Examples of a binder include a fluorocarbon resin, such as polytetrafluoroethylene (PTFE), polyvinylidene-fluoride (PVdF), and a fluorocarbon rubber; a thermoplastic resin, such as polypropylene, polyethylene, and polyacrylonitrile; and a styrene butadiene rubber (SBR). Preferably, the binder occupies 1 to 40 wt % of the first layer and the second layer respectively.

The first layer and the second layer may contain an oxidation-reduction catalyst. Examples of the oxidation-reduction catalyst include a metallic oxide, such as manganese dioxide, cobalt oxide, and cerium oxide; a noble metal, such as Pt, Pd, Au, and Ag; a transition metal such as Co; a metal phthalocyanine such as cobalt phthalocyanine; and an organic material such as Fe-porphyrin. Preferably, the oxidation-reduction catalyst occupies 1 to 90 wt % of the first layer and the second layer respectively.

As a material of the solid electrolyte contained in an air electrode, a material applicable as a solid electrolyte for an all-solid state battery may be used, and a solid electrolyte having lithium-ion electrical conductivity may be used preferably.

As the solid electrolyte material contained in an air electrode, a sulfide type solid electrolyte, such as Li₂S—SiS₂, LiI—Li₂S—P₂S₅, Li₃PO₄—Li₂S—Si₂S, Li₃PO₄—Li₂S—SiS₂, LiPO₄—Li₂S—SiS, LiI—Li₂S—P₂O₅, LiI—Li₃PO₄—P₂S₅, and Li₂S—P₂S₅; an oxide type amorphous solid electrolyte, such as Li₂O—B₂O₃—B₂O₅, Li₂O—SiO₂, Li₂O—B₂O₃, and Li₂O—B₂O₃—ZnO; a crystalline oxide, such as Li_{1.3}Al_{0.3}Ti_{0.7}(PO₄)₃, Li_{1+x+y}AₓTi₂₋ₓSi_{y}P_{3-y}O₁₂ (A is Al or Ga, 0≦x≦0.4, 0<y≦0.6), [(B_{1/2}Li_{1/2})_{1-z}C_{z}]TiO₃ (B is La, Pr, Nd, or Sm, C is Sr or Ba, 0≦z≦0.5), Li₅La₃Ta₂O₁₂, Li₇La₃Zr₂O₁₂ (LLZO) Li₆BaLa₂Ta₂O₁₂, or Li_{3.6}Si_{0.6}Ta_{0.4}O₄; a crystalline oxynitride such as Li₃PO_{(4-3/2w)}N_{w} (w<1); or LiI, LiI—Al₂O₃, Li₃N, Li₃N—LiI—LiOH, or the like may be used. Further, as the solid electrolyte, a semi-solid polymer electrolyte, such as polyethylene oxide, polypropylene oxide, polyvinylidene-fluoride, and polyacrylonitrile, containing a lithium salt, may be also used.

Although there is no particular restriction on the thicknesses of the first layer and the second layer contained in the air electrode according to the present invention, they may be, for example, 10 to 200 μm.

Although there is no particular restriction on the thickness of the solid electrolyte layer contained in the air electrode according to the present invention, it may be, for example, 10 to 200 μm.

With respect to the air electrode according to the present invention, insofar as it has a constitution in which layers containing a carbon material are positioned on the gas side (oxygen intake hole side) and on the opposite negative electrode side of the air electrode and a solid electrolyte layer is positioned between them, any variation in the constitution is allowable. For example, in addition to the first layer and the second layer, there may be a third layer or more layers having a similar constitution, or there may be two or more solid electrolyte layers, and such two or more solid electrolyte layers may be adjacent to each other, or apart from each other intercalating a layer containing a carbon material between them.

The metal air battery produced with the air electrode according to the present invention may include the layers of the air electrode as described above, a negative electrode layer, and an electrolyte layer between the air electrode layer and the negative electrode layer.

The electrolyte layer conducts metal ions between the air electrode layer and the negative electrode layer, and may contain a liquid electrolyte, a solid electrolyte, a gel electrolyte, a polymer electrolyte, or a combination thereof. A liquid electrolyte and a gel electrolyte may penetrate into pores (voids) in the air electrode layer.

As the liquid electrolyte which may be contained in an electrolyte layer between the air electrode layer and the negative electrode layer, a liquid which can exchange metal ions between the air electrode layer and the negative electrode layer, can be used. The liquid may be an aprotic organic solvent, an ionic liquid, or the like.

Examples of the organic solvent include propylene carbonate, ethylene carbonate, diethyl carbonate, dimethyl carbonate, ethyl methyl carbonate, 1,2-dimethoxyethane, 1,2-diethoxyethane, acetonitrile, propionitrile, tetrahydrofuran, 2-methyltetrahydrofuran, dioxane, 1,3-dioxolane, nitromethane, N,N-dimethylformamide, dimethyl sulfoxide, sulfolane, γ-butyrolactone, and glymes

The ionic liquid are preferably those having high resistance to an oxygen radical and being able to suppress a side reaction, and examples thereof include N,N-diethyl-N-methyl-N-(2-methoxyethyl)ammonium bis(trifluoromethanesulfonyl)amide (DEMETFSA), N-methyl-N-propylpiperidinium bis(trifluoromethanesulfonyl)amide (PP13TFSA), and a combination thereof. Further, as the liquid electrolyte, a combination of the ionic liquid and the organic solvent as described above may be used.

A supporting electrolyte may be dissolved in the liquid electrolyte. As the supporting electrolyte, for example, a salt composed of a lithium ion and an anion listed below may be used:

a halide anion, such as Cl⁻, Br⁻, and I⁻; a boride anion, such as BF₄⁻, B(CN)₄⁻, and B(C₂O₄)₂⁻; an amide anion or an imide anion, such as (CN)₂N⁻, [N(CF₃)₂]⁻, and [N(SO₂CF₃)₂]⁻; a sulfate anion or a sulfonate anion, such as RSO₃⁻ (R means hereinafter an aliphatic hydrocarbon group or an aromatic hydrocarbon group), RSO₄⁻, R^{f}SO₃⁻ (R^{f} means hereinafter a fluorine-containing halogenated hydrocarbon group), and R^{f}SO₄⁻; a phosphorus-containing anion, such as R^{f}₂P(O)O⁻, PF₆⁻, and R^{f}₃PF₃⁻; an antimony-containing anion such as SbF₆; or an anion of a lactate, a nitrate ion, trifluoroacetate, or tris(trifluoromethanesulfonyl)methide.

Examples of the supporting electrolyte include LiPF₆, LiBF₄, lithium bis(trifluoromethanesulfonyl)amide (LiN(CF₃SO₂)₂ₜ hereinafter referred to as “LiTFSA”), LiCF₃SO₃, LiC₄F₉SO₃, LiC(CF₃SO₂)₃ and LiClO₄, and LiTFSA may be used preferably. A combination of two kinds or more of such supporting electrolytes may be also used Although there is no particular restriction on the addition amount of the supporting electrolyte to the liquid electrolyte, approximately 0.1 to 1 mol/kg is preferable.

The polymer electrolyte which may be contained in the electrolyte layer positioned between the air electrode layer and the negative electrode layer, may be used together with, for example, an ionic liquid and contain preferably a lithium salt and a polymer. As the lithium salt, for example, a lithium salt used as the supporting electrolyte as described above may be used. As the polymer, there is no particular restriction insofar as it can form a complex with the lithium salt, and examples thereof include polyethylene oxide.

The gel electrolyte which may be contained in the electrolyte layer positioned between the air electrode layer and the negative electrode layer, may be used together with, for example, an ionic liquid and contain preferably a lithium salt, a polymer, and a nonaqueous solvent. As the lithium salt, the above lithium salt may be used. As the nonaqueous solvent, there is no particular restriction insofar as it can dissolve the lithium salt, and, for example, the above organic solvent may be used. The nonaqueous solvents may be singly used, or in combination of two kinds or more. As the polymer, there is no particular restriction insofar as it can cause gelation, and examples thereof include polyethylene oxide, polypropylene oxide, polyacrylonitrile, polyvinylidene-fluoride (PVdF), polyurethane, polyacrylate, and cellulose.

As a material of the solid electrolyte which may be contained in the electrolyte layer positioned between the air electrode layer and the negative electrode layer, a material which is applicable as a solid electrolyte for an all-solid state battery, may be used, and any of the solid electrolyte materials contained in the air electrode as described above or a combination thereof may be used. Preferably, the same solid electrolyte material as contained in the air electrode may be used.

The electrolyte layer included in the metal air battery to be produced using the air electrode according to the present invention may be provided with a separator. Although there is no particular restriction on the separator, it may include, for example; a polymeric nonwoven fabric, such as a polypropylene nonwoven fabric and a polyphenylene sulfide nonwoven fabric, a microporous film of an olefinic resin, such as polyethylene and polypropylene, or a combination thereof. The electrolyte layer may be formed, for example, by impregnating a liquid electrolyte, etc., in the separator.

The negative electrode layer included in the metal air battery to be produced using the air electrode according to the present invention is a layer containing a negative electrode active material containing a metal. As the negative electrode active material, a metal, an alloy material, a carbon material, etc., may be used. Examples of the negative electrode active material include an alkali metal, such as lithium, sodium, and potassium; an alkaline earth metal, such as magnesium and calcium; the group 13 element such as aluminum; a transition metal, such as zinc, iron, and silver; an alloy material containing the above metals or a material containing the above metals, a carbon material such as graphite, and a negative electrode material used in a lithium-ion battery, etc.

When a material containing lithium is used as a negative electrode active material, a carbonaceous material of lithium, an alloy containing lithium element, or an oxide, a nitride, or a sulfide of lithium may be used as the material containing lithium. Examples of the alloy containing lithium element include a lithium aluminum alloy, a lithium tin alloy, a lithium lead alloy, and a lithium silicon alloy. Examples of the metallic oxide containing lithium element include a lithium titanium oxide. Examples of the metal nitride containing lithium element include a lithium cobalt nitride, lithium iron nitride, and lithium manganese nitride.

The negative electrode layer may further contain an electroconductive material and/or a binder. If, for example, the negative electrode active material is in a form of a foil, the negative electrode layer may contain only the negative electrode active material, and if the negative electrode active material is powdery, the negative electrode layer may contain the negative electrode active material and the binder. The electroconductive material and the binder may be the same as the carbon material such as carbon and the binder which may be used for the air electrode as described above.

As an outer package which may be used for the metal air battery produced using the air electrode according to the present invention, materials normally used as an outer package for an air battery, such as a metallic can, a resin, and a laminate pack, may be used.

In the outer package, a hole for supplying oxygen may be provided at any position, for example toward a surface of the air electrode layer in contact with air. An oxygen source is preferably dry air or pure oxygen.

The metal air battery produced using the air electrode according to the present invention may include an oxygen permeable membrane. The oxygen permeable membrane may be positioned, for example, on the air electrode layer, and particularly positioned on the air-contacting side opposite to the electrolyte layer side. As the oxygen permeable membrane, a porous membrane which allows oxygen in the air to pass and is water-repellent preventing entry of moisture, may be used, and, for example, a porous membrane of polyester or polyphenylene sulfide may be used. A water-repellent membrane may be provided separately.

An air electrode collector may be positioned adjacent to the air electrode layer. The air electrode collector may be positioned normally on the air electrode layer, and particularly on the air-contacting side opposite to the electrolyte layer side, but it may be positioned also between the air electrode layer and the electrolyte layer. As the air electrode collector, materials which have been used heretofore, such as a porous structure, a network structure, a fiber, and a nonwoven fabric, including a carbon paper, metal mesh, etc., may be used without particular restrictions, and for example, a metal mesh made of stainless steel, nickel, aluminum, iron, titanium, or the like may be used. As the air electrode collector, a metallic foil with oxygen supply holes may, be used.

A negative electrode collector may be positioned adjacent to the negative electrode layer. As the negative electrode collector, materials which have been used heretofore, such as an electrical-conductive substrate with a porous structure, and a holeless metallic foil, may be used without particular restrictions, and for example, a metallic foil made of copper, stainless steel, nickel, or the like may be used.

There is no particular restriction on the shape of the metal air battery produced using the air electrode according to the present invention insofar as it is the shape having an oxygen intake hole, and the metal air battery may have a desired shape including a cylindrical shape, a square shape, a button shape, a coin-shape, and a flat shape.

Although the metal air battery produced using the air electrode according to the present invention can be used as a secondary battery, it may be also used as a primary battery.

Formation of the air electrode layer and the negative electrode layer which are included in the metal air battery produced using the air electrode according to the present invention may be carried out by any heretofore known method. For example, if an air electrode layer containing a carbon particle and a binder is formed, an appropriate amount of a solvent such as ethanol is added to predetermined amounts of a carbon particle and a binder and mixed, and the obtained mixture is rolled by a roll press to a predetermined thickness, and then dried and cut to form the air electrode layer. An air electrode collector is then pressure bonded thereto followed by vacuum drying with, heating to form the air electrode layer combined with the collector.

As an alternative method, an appropriate amount of a solvent is added to predetermined amounts of a carbon particle and a binder and mixed to obtain a slurry, which is coated on a substrate and dried to form an air electrode layer. If desired, the formed air electrode layer may be pressed. As the solvent for obtaining the slurry, acetone, NMP, etc., having a boiling point of 200° C. or less may be used Examples of a coating process for the slurry on to a substrate include a doctor blade process, a gravure transfer process, and an ink jet process. There is no particular restriction on a substrate which can be used, a collector plate which may be used as a collector, a flexible substrate in a form of a film, and a hard substrate may be used, and examples thereof include a stainless steel foil, a polyethylene terephthalate (PET) film, and a Teflon (registered trademark). The same holds true for a formation process of the negative electrode layer.

### EXAMPLES

### Production of Cell

### Example 1

Ketjen black (KB) (ECP-600JD, by Ketjen Black International Co.) and a polytetrafluoroethylene (PTFE) binder (F-104, by Daikin Industries, Ltd.) at a weight ratio of 4:3 and an appropriate amount of ethanol as a solvent were mixed to obtain a mixture. The obtained mixture was rolled by a roll press, dried and cut to form two sheets of a 70 μm-thick mixture electrode of Ketjen black and PTFE.

A powder of Li₇La₃Zr₂O₁₂ (LLZO) (by KCM Corporation Co., Ltd.) was prepared. A 10 μm-thick solid electrolyte layer of the LLZO powder was placed between the two sheets of the mixture electrode of Ketjen black and PTFE such that the weight ratio of KB:PTFE:LLZO in the entire air electrode was 40:30:30, and a 150 μm-thick air electrode layer shown in FIG. 1 was formed.

Using a 100 mesh stainless steel (SUS304) net (by The Nilaco Corporation) as an air electrode collector, the air electrode layer and the air electrode collector were press bonded together, followed by vacuum drying with heating.

Using N,N-diethyl-N-methyl-N-(2-methoxyethyl)ammonium bis(trifluoromethanesulfonyl)amide (DEMETFSA, by Kanto Chemical Co., Ltd.) as a solvent, a lithium salt of lithium bis(trifluoromethane sulfonyl)amide (LiTFSA, by Kishida Chemical Co., Ltd.) was mixed and dissolved to a concentration of 0.32 mol/kg at 25° C. for 12 hours in an Ar atmosphere to prepare an electrolyte solution.

A metallic lithium foil (by Honjo Metal Co., Ltd.) was prepared as a negative electrode layer, and adhered to a negative electrode collector made of a stainless steel (SUS304) foil (by The Nilaco Corporation).

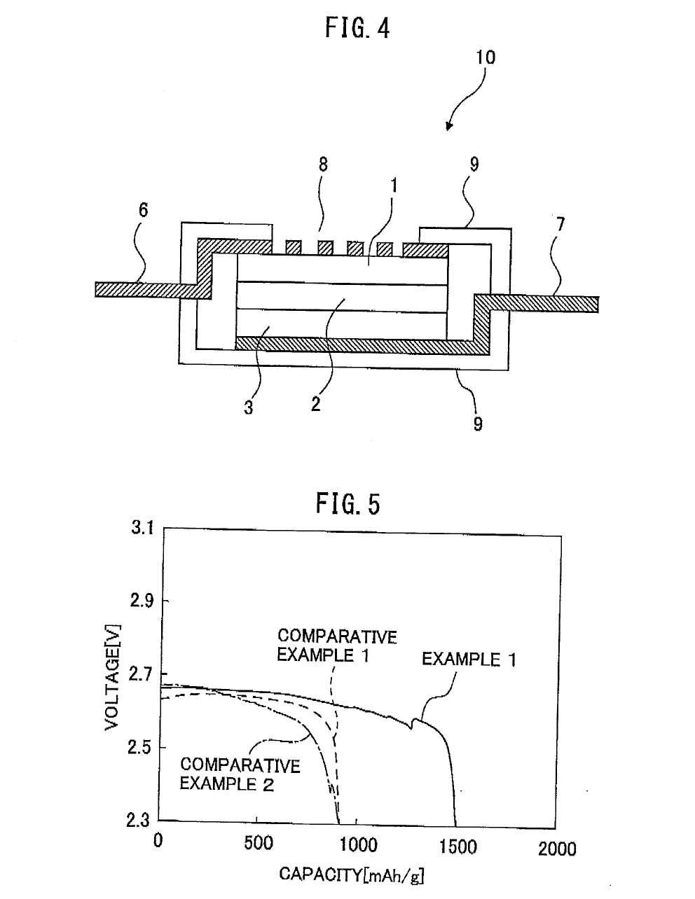

As shown in FIG. 4, a negative electrode collector 7, a negative electrode layer 3, a separator made of a polypropylene nonwoven fabric, an air electrode layer 1, and an air electrode collector 6 in a net form were arranged in an Ar atmosphere to constitute an electrode assembly, and inserted in an outer package 9 in a form of a polypropylene/aluminum lamination film bag provided with an oxygen intake hole 8 on the air electrode side. A seal tape was stuck in advance to the outside of the oxygen intake hole 8 of the outer package 9. The air electrode collector 6 and the negative electrode collector 7 were led out outward through un-sealed openings of the outer package 9. Then, the prepared electrolyte solution was injected through the openings into the separator to form an electrolyte layer 2, and the openings of the outer package 9 were then closed by a thermal fusion treatment to produce an electrochemical cell 10.

The electrochemical cell 10 was then placed in a glass desiccator (volume: 500 mL) with a cock for gas replacement, and the atmosphere in the glass desiccator was replaced with pure oxygen (99.9%, by Taiyo Nippon Sanso Corporation) to an oxygen atmosphere.

### Comparative Example 1

40 wt % of Ketjen black (KB), 30 wt % of a polytetrafluoroethylene (PTFE) binder, 30 wt % of a Li₇La₃Zr₂O₁₂ (LLZO) powder, and an appropriate amount of ethanol as a solvent were mixed to obtain a mixture. The obtained mixture was rolled by a roll press, dried and cut to form a 150 μm-thick air electrode layer shown in FIG. 2.

Except that the air electrode layer was formed, as described above, a cell for evaluation was produced as in Example 1, and placed in the glass desiccator, and the atmosphere in the glass desiccator was replaced with an oxygen atmosphere.

### Comparative Example 2

40 wt % of Ketjen black (KB), 30 wt % of a polytetrafluoroethylene (PTFE) binder, 30 wt % of a Li₇La₃Zr₂O₁₂ (LLZO) powder, and an appropriate amount of ethanol were mixed to obtain a mixture. The obtained mixture was rolled by a roll press, dried and cut to form two sheets of a 75 μm-thick mixture electrode of KB, PTFE, and LLZO. The two sheets of mixture electrode were stacked to form a 150 μm-thick air electrode layer shown in FIG. 3.

Except that the air electrode layer was formed, as described above, a cell for evaluation was produced as in Example 1, and placed in the glass desiccator, and the atmosphere in the glass desiccator was replaced with an oxygen atmosphere.

### (Discharge Test)

The cells for evaluation produced in Example 1 and Comparative Examples 1 and 2 and placed in the glass desiccator were allowed to stand in a thermostatic chamber at 60° C. for 3 hours prior to start of tests. The seal tape stuck to the oxygen intake hole 8 was then removed and the discharge characteristic was measured at a discharge current density of 0.1 mA/cm² by a charge and discharge measuring apparatus BTS2004 (by Nagano & Co., Ltd.) under conditions of 60° C., pure oxygen, and 1 atmospheric pressure.

FIG. 5 shows the discharge characteristics of the cells produced in Example 1 and Comparative Examples 1 and 2, and Table 1 indicates the capacities of the cells.

TABLE 1

| | Capacity (mAh/g) |
|---|---|
| Example 1 | 1499 |
| Comparative Example 1 | 916 |
| Comparative Example 2 | 912 |

The cell produced in Example 1 exhibited approximately 1.6-fold improvement in discharge characteristic compared to the cell produced in Comparative Example 1. The discharge capacities of the cells produced in Comparative Example 1 and Comparative Example 2 were almost same.

### REFERENCE SIGNS LIST

1 Air electrode layer
2 Electrolyte layer
3 Negative electrode layer
6 Air electrode collector
7 Negative electrode collector
8 Oxygen intake hole
9 Outer package
10 Electrochemical cell
11 First layer
12 Second layer
13 Solid electrolyte layer

1. An air electrode for a metal air battery provided with a layered body comprising:
a first layer comprising a carbon material,
a second layer comprising a carbon material, and
an intermediate layer comprising a solid electrolyte and positioned between the first layer and the second layer.

2. A metal air battery comprising an air electrode layer comprising the air electrode according to claim 1, a negative electrode layer, and an electrolyte layer between the air electrode layer and the negative electrode layer.

3. The metal air battery according to claim 2, wherein the negative electrode layer comprises a material containing lithium.

4. The metal air battery according to claim 2, wherein the electrolyte layer comprises a liquid electrolyte containing an ionic liquid.

5. The metal air battery according to claim 4, wherein the ionic liquid is N,N-diethyl-N-methyl-N-(2-methoxyethyl)ammonium bis(trifluoromethanesulfonyl)amide (DEMETFSA), or N-methyl-N-propylpiperidinium bis(trifluoromethanesulfonyl)amide (PP13TFSA), or a combination thereof.

6. The metal air battery according to claim 4, wherein the liquid electrolyte comprises a lithium-containing metal salt.

7. The metal air battery according to claim 6, wherein the lithium-containing metal salt is lithium bis(trifluoromethanesulfonyl)amide (LiTFSA).

8. The metal air battery according to claim 3, wherein the electrolyte layer comprises a liquid electrolyte containing an ionic liquid.

9. The metal air battery according to claim 8, wherein the ionic liquid is N,N-diethyl-N-methyl-N-(2-methoxyethyl)ammonium bis(trifluoromethanesulfonyl)amide (DEMETFSA), or N-methyl-N-propylpiperidinium bis(trifluoromethanesulfonyl)amide (PP13TFSA), or a combination thereof.

10. The metal air battery according to claim 8, wherein the liquid electrolyte comprises a lithium-containing metal salt.

11. The metal air battery according to claim 10, wherein the lithium-containing metal salt is lithium bis(trifluoromethanesulfonyl)amide (LiTFSA).

12. The metal air battery according to claim 5, wherein the liquid electrolyte comprises a lithium-containing metal salt.

13. The metal air battery according to claim 12, wherein the lithium-containing metal salt is lithium bis(trifluoromethanesulfonyl)amide (LiTFSA).

14. The metal air battery according to claim 9, wherein the liquid electrolyte comprises a lithium-containing metal salt.

15. The metal air battery according to claim 14, wherein the lithium-containing metal salt is lithium bis(trifluoromethanesulfonyl)amide (LiTFSA).
